(19) United States
(12) Patent Application Publication
(10) Pub. No.: US 2016/0155067 A1
(43) Pub. Date: Jun. 2, 2016

(54) Mapping Documents to Associated Outcome based on Sequential Evolution of Their Contents

(71) Applicants: Shlomo Dubnov, San Diego, CA (US); Tammuz Dubnov, San Diego, CA (US)

(72) Inventors: Shlomo Dubnov, San Diego, CA (US); Tammuz Dubnov, San Diego, CA (US)

(21) Appl. No.: 14/948,122

(22) Filed: Nov. 20, 2015

Related U.S. Application Data
(60) Provisional application No. 62/082,207, filed on Nov. 20, 2014.

(51) Int. Cl. G06N 99/00; G06F 17/28; G06N 7/00

(52) U.S. Cl. CPC G06N 99/005; G06N 7/005; G06F 17/2872

(57) ABSTRACT

A method and system is described for modeling the content evolution of an accessed document and predicting an associated outcome for said document. The system accesses a document but can further receive additional tags, metadata, or related information that characterizes the nature of such text collection. The invention applies various processing to separate the document into elements and performs semantic modeling to create a narrative model that describes the evolution of the contents of the elements in terms of their respective sequencing. This system then uses a set of training documents with target values assigned to them to predict an associated outcome for the accessed document. The most relevant subset of a training set can be selected by matching metadata information that characterize the accessed document and a collection of metadata that characterize other broad document sets. Such characterization is done using graph partitioning or other community detection methods from metadata information that characterize the document sets and relations between multiple sets of such documents. The outcome of the method may apply to prediction of economic value of a events described by the accessed document, success measures of the document quality, or discovery of related content with similar associated outcome to the accessed document.

This application claims the benefit of U.S. Provisional Application No. 62/082,207, filed on Nov. 20, 2014, and entitled Mapping Sequence of Documents to Target Function based on Time Evolution of Their Contents. U.S. Provisional Application No. 62/082,207 is herein incorporated by reference in its entirety.

### FIELD OF INVENTION

The methods and systems described herein relate to automated forecasting and prediction based on analysis of text, statistical analysis, and mining of data extracted from text.

### BACKGROUND ART

In many digital media, live and recorded entertainment productions, the sequence of activities required for producing a film, performance or a game, are described in a document or set of documents such as a movie, stage or game script. Sequences of documents may describe operations that occur during execution of a project, such as protocols of meetings, email exchanges and other notebooks or logs of activities that happened during the execution of the project. It is desirable to be able to track the evolution of information and expression in such documents to detect patterns, changes or important events over time. Such detections can be used to evaluate or predict a variety of performance measures of a proposed set of activities.

As one possible embodiment of this invention, the analysis of the documents can be applied as part of an evaluation of film scripts. Decisions regarding investment and commercialization of films have traditionally been made in a subjective and whimsical manner. In major studios, it is common practice to adopt the decisions of a small handful of decision makers, even when the success of their decisions has not been empirically studied. Many books have been published in an attempt to guide prospective screenwriters in their journey to author the next big hit in the movie industry. This is clearly a difficult task, as many different and conflicting schools of thought have been prominent, each claiming to be the best method for getting a script approved. Yet most of these have one resounding theme in common—that the structure of a story is the single most important element of writing and selling a screenplay.

For example, some strategies involve the idea of the “beat sheet”. This story form breaks a film story into three acts, each of which can further be broken into smaller story elements called beats. Each beat takes up approximately one page, given a standard 110-page screenplay. Proponents of using the beat sheet note that there is indeed a structure that underlies well-written films. Therefore, the question lies—can such a structure be discovered by algorithms, and can such a structure be used to predict the success of a film?

### SUMMARY OF THE INVENTION

Below are described a method and system is described for modeling the content evolution of an accessed document and predicting an associated outcome for said document. The system accesses a document but can further receive additional tags, metadata, or related information that characterizes the nature of such text collection. The invention applies various processing to separate the document into elements and performs semantic modeling to create a narrative model that describes the evolution of the contents of the elements in terms of their respective sequencing. This system then uses a set of training documents with target values assigned to them to predict an associated outcome for the accessed document. The most relevant subset of a training set can be selected by matching metadata information that characterize the accessed document and a collection of metadata that characterize other broad document sets. Such characterization is done using graph partitioning or other community detection methods from metadata information that characterize the document sets and relations between multiple sets of such documents. The outcome of the method may apply to prediction of economic value of a events described by the accessed document, success measures of the document quality, or discovery of related content with similar associated outcome to the accessed document.

One embodiment of the proposed system can centralize around film pre-production documents. The documents referred to includes, but is not limited to, the text of the film script, synopsis of the film, tags and metadata that describe the genre of the film, casting and talent data, budget, release schedule, target audience and other general and distinctive properties of the proposed film, with the purpose of the analysis to provide a ranking or quantitative evaluation of the quality or some other target function of these documents.

One goal of this analysis is to use features describing story contents and story structure that are extracted from the scenes of a film script to predict the Return On Investment (ROI) of a particular film. Such a tool could provide film script writers with an objective and empirical way to evaluate the quality of their film scripts. This tool could potentially have a large impact on the film industry, providing producers, studios, film financiers, film investors and even actors, with a service that could be useful in giving an objective analysis of the potential success of a particular film script. In another embodiment the sequence of documents may pertain to a documentation of project management activities, email logs or any other textual representation of organizational activity. In another embodiment, the ordering of document elements is done in multiple time lines, with possibility of branching or concurrent elements. The described system derives a set of semantic descriptors for the given documents using a variety of machine learning and artificial intelligence techniques, such as natural language processing. The semantic descriptors may involve topic vectors for individual scenes or some predefined breakpoints within the documents, sentiment analysis descriptors and similar descriptors derived from automatic text analysis.

These techniques can be applied as part of a two-step approach. For example, the first step can involve applying methods from natural language processing to extract the story structure from the raw text of the film script. This process involves representing each film script as a set of scenes and representing each scene in terms of distributed word vectors derived from a statistical analysis. The statistical analysis may involve a variety of methods such as the computation of eigenvectors of document-term matrices, representations in terms of activation of hidden units in a multi-layer neural network, or parameter estimation in a graphical model using a mixture of topics. This analysis represents individual scenes by a set of values or vectors. These sets of values or vectors facilitate construction of a narrative trajectory that captures the changes in document contents by computation of similarity between scenes over time.

Using a combination of features extracted from the documents and from the evolution in time of the documents content, using machine learning methods it is possible to map these features to a target value or target category by training a decision or regression function on historical data. Such mapping can be constructed using a variety of techniques, such as Bayesian classifiers that learn probabilities of target values or labels given the features and use these probabilities to predict a label or value on new data. Other methods may include kernel methods that map the feature to some higher dimensional space with non-linear functions prior to making the classification. Another optimal mapping can be achieved by using an ensemble of classifiers such as a combination of multiple decision trees. In one embodiment of this system, a mapping of features extracted from a sequence of scenes, in a film script, is used to predict the profitability of a that movie regarding its return on investment (ROI).

In order to make the prediction as precise as possible, the set of training documents can be associated with communities based on metadata that describes their overall contents. The metadata may include but is not limited to, human or automatically derived choices or ranking on questionnaires or other criteria related to the documents at hand. The target function prediction can use a combination of predictors trained in each community, weighted by their similarity to the set of documents analyzed.

The result of the semantic analysis consists of a set of semantic vectors ordered according to their appearance in the sequence, such as chronological arrangement in time or scene order in movie scripts, or any other time indexing or representation of the evolution of the story. These multi-dimensional vectors may be subject to a dimension reduction techniques that will summarize the evolution of semantics in time using fewer dimensions. The results of this analysis may be used to graphically represent the content narrative trajectory in one, two or three dimensional plots as graphs or trajectories in the semantic space chosen during the dimension reduction stage. The user may specify the choice of the representation and selection of the dimensions, or it may be selected automatically by the system.

The entire or dimension-reduced semantic descriptor vectors, which include topic vectors, sentiment vectors, tags and other descriptors, are further processed during the analysis stage. The time evolution of the semantic parameters, or semantic trajectory, is translated to a fixed number of model coefficients using one of a variety of functional analysis or regression methods. These coefficients or functional modeling parameters are used to represent the time structure of the documents, such as a film script, in a manner that allows comparison and calculation of similarity across different documents, such as other film scripts, having different amounts of elements. Combined with other tags and descriptors representing the contents of the document, we construct a narrative model that allows deriving conclusions regarding the overall contents and changes of contents in time. In the film related embodiment, the system uses these time modeling coefficients to represent films of various durations and film scripts of different lengths and different numbers of scenes in such a way that features derived from their narrative models are comparable. The number of parameters is determined automatically based on the best prediction or scoring qualities, as determined in a later prediction phase. Alternatively, the number of parameters can be manually set by the user, or a combined method may be used to set the number. Without limiting the scope of the invention, these parameters may be replaced by other parameters representing temporal models that map the time trajectory of the content in semantic space to a set of narrative model parameters.

Following the derivation of a narrative model, the system moves to a prediction phase where one or more classification algorithms are used to map the narrative parameters to a target value or some other numerical or categorical characterization. In a possible screenplay analysis embodiment, such numerical characterizations may express expected profit associated with the film script, such as ROI or other measures indicative of the movie success, audience taste or script quality assessment. The system includes a training phase where the parameters of the predictors are estimated based on other scripts, their corresponding related data (such as casting, budgeting, time of release, etc.) and historical data describing their success. The user can potentially specify the criteria for the success target data he is interested in. Where the user can be an individual or a group that provides their personalized judgments, a studio indicating their portfolio selection criteria based on historical data, or any other available information, such as box-office as the success metric for a movie's performance. One possible embodiment of the prediction is using bagging of classification and regression trees. Another possible embodiment uses a forest of decision trees with a random selection of the subsets of narrative parameters. Another possible embodiment uses support vector machine.

These models are trained on parameters extracted from a set of documents with target values derived from historical data. Returning to the potential film embodiment, the target value can be set to the profitability of films (and their script) represented as the ROI derived from the production budget and film box office data. In another embodiment, the target value for films can be categories of top, mediocre and bottom quality or profitability. Another embodiment uses audience ranking. The target data can be for the U.S. or International distribution of films, opening weekend revenues or total film revenues, or revenues from specific distribution channels such as a particular territory, DVD or online showing. Furthermore in the case of films, prior to making the prediction, the appropriate set of predictors can be selected by associating the current film script to a community of films that is determined using the movie-genome and other related data derived automatically or provided by the user. The determination of the movie-community may be essential for making the correct predictions for a specific subset of movies, such as movie genre, mood, style, and time period depending on the target function.

Further embodiment examples of predicting movie scripts profitability is described in the detailed description. It should be noted that the invention is not limited to such usage. The invention may be applied to other domains such as quality ranking of threads in online forums, analysis of email logs, analysis collections of minutes from meetings, project management data, historical data from project review panels and so on. The target values could be popularity, quality ranking, success rate, policy effectiveness, or any other assessment of sets of sequential texts to categorical or numerical values representing an evaluation that is meaningful to the user.

### BRIEF DESCRIPTION OF THE DRAWINGS

FIG. 1 is a diagram view of a computing environment in which the proposed system can be executed.

FIG. 2 is a flowchart illustrating the details of a generalized method described herein, which can be executed by the system in FIG. 1.

FIG. 3 is a flow diagram outlining additional details that may be used in the transition of the narrative model into an input for the prediction of the associated outcome.

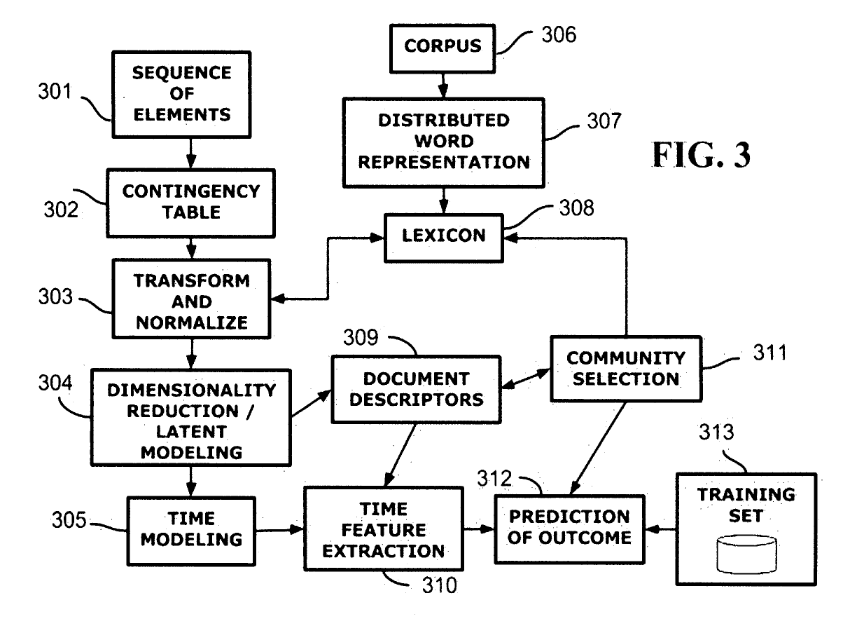

FIG. 4 is a flowchart illustrating the details of creating and identifying communities.

FIG. 5 an example embodiment of the system described herein.

### DETAILED DESCRIPTION

In the following detailed description, numerous specific details are set forth in order to provide a thorough understanding of the invention. However, the present invention may be practiced without these specific details. The embodiments of the invention described in the present disclosure will be depicted in detail by way of example with reference to the accompanying drawings. The drawings are not drawn to scale, and the illustrated components are not necessarily drawn proportionally to one another. Throughout this description, the embodiments and examples shown should be considered as being provided for the purpose of explanation and understanding, rather than as limitations of the present disclosure. In the context of this particular specification, the term “specific apparatus” or the like covers, amongst other things, a general purpose computer. Algorithmic descriptions or symbolic representations are examples of techniques used by those skilled in the art. An algorithm is considered to be a self-consistent sequence of operations or similar data processing leading to the desired result. In this context, operations or processing involve manipulation of data that may represent, amongst other things, a set of analyzed documents. Typically, although not necessarily, such data may take the form of electrical or magnetic signals capable of being stored, transferred, combined, compared or otherwise manipulated. It has proven convenient at times, principally for reasons of common usage, to refer to such data as bits, data, values, symbols, characters, terms, numbers, numerals or the like. It should be understood, however, that all of these or similar terms are to be associated with appropriate physical quantities and are merely convenient labels. Furthermore, references to various aspects of the disclosure throughout this document do not mean that all claimed embodiments or methods must include the referenced aspects.

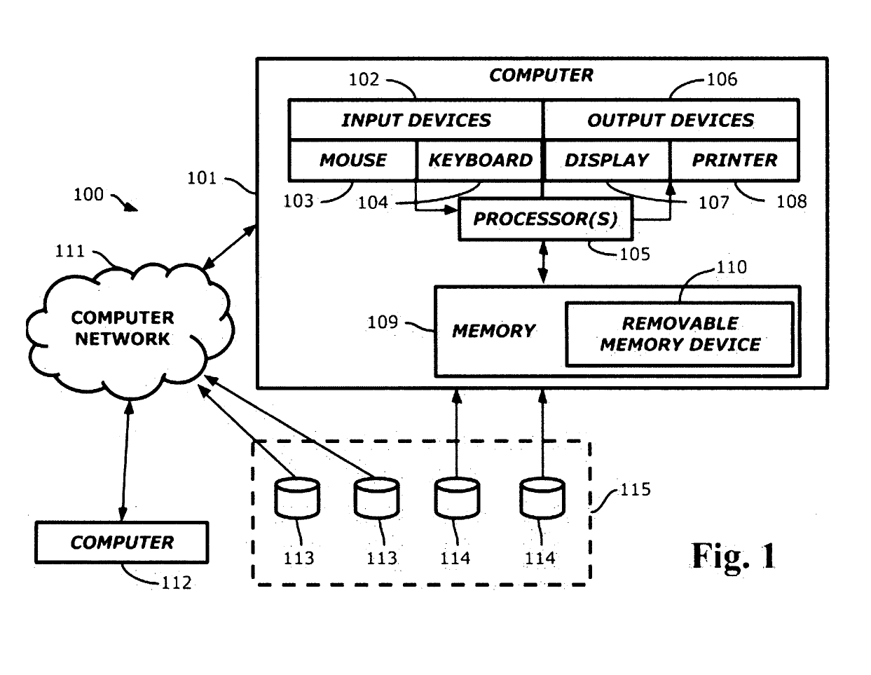

FIG. 1 diagrammatically depicts a computer system 100 of an embodiment of the present invention. The system 100 includes computer 101 with processor 105 that can be any type of processor that is configured to operate in accordance with programming instructions and/or another form of operating logic. The system 100 further includes operator input devices 102 and operator output devices 106 operatively connected to processor 105. The input devices 102 include a conventional mouse 103 and keyboard 104, and alternatively or additionally can include a different input device type as would occur to those skilled in the art. Output devices 106 include a conventional graphic display 107, such as a liquid crystal display (LCD) type, and color or non-color printer 108. Alternatively or additionally output devices 106 can include any output device type as would occur to those skilled in the art. Further, in other embodiments, more or fewer operator input devices 102 or operator output devices 106 may be utilized. System 100 also includes memory 109 operatively connected to processor 105. The memory 109 can be of one or more types, such as solid-state electronic memory, magnetic memory, optical memory, or a combination of these. Memory 106 can include a removable memory devices 110, such as a flash drive, that can be in any form as would occur to those skilled in the art. In an embodiment, at least a portion of memory 109 is operable to store programming instruction for selective execution by processor 105. Alternatively or additionally, memory 109 can be arranged to store data other than programming instructions for processor 105. In other embodiments memory 109 and/or removable memory devices 110 may not be present.

System 100 also includes computer network 111, which can be a Local Area Network (LAN), Wide Area Network (WAN) such as the Internet, another type as would occur to those skilled in the art, or a combination of these. Network 111 couples computer 101 to computer 112; where computer 112 is remotely located relative to computer 101. Computer 112 can include a processor, input devices, output devices, and/or memory as described in connection with computer 101; however these features of computer 112 are not shown in order to preserve clarity. Computer 112 and computer 101 can be arranged as client and server, respectively, in relation to some or all of the data processing of the present invention. For this arrangement, it should be understood that many other remote computer 112 could be included as clients of computer 101, but are not shown to preserve clarity. In another embodiment, computer 101 and computer 112 can both be participating members of a distributed processing arrangement with one or more processors located a different site relative to the others. The distributed processor of such an arrangement can be used collectively to execute routines according to the present invention. In another embodiment, remote computer 112 may be absent.

Operating logic for processor 105 is arranged to facilitate performance of various routines, subroutines, procedures, stages, operations, and/or conditionals described hereinafter. This operating logic can be of a dedicated, hardwired variety and/or in the form of programming instructions as is appropriate for the particular processor arrangement. Such logic can be at least partially encoded on device 110 for storage and/or transport to another computer. Alternatively or additionally, the logic of computer 101 can be in the form of one or more signals carried by a transmission medium, such as network 111. System 100 is also depicted with computer-accessible data sources or datasets generally designated as corpora 115, such as the set of target values, training documents, metadata and/or factors. Corpora 115 include datasets 114 local to computer 101 and remotely located datasets 113 accessible via network 111. Computer 101 is operable to process data selected from one or more of corpora 115. The one or more corpora 113 can be accessed with a data extraction routine executed by processor 105 to selectively extract routine executed by processor 105 to selectively extract information according to predefined criteria.

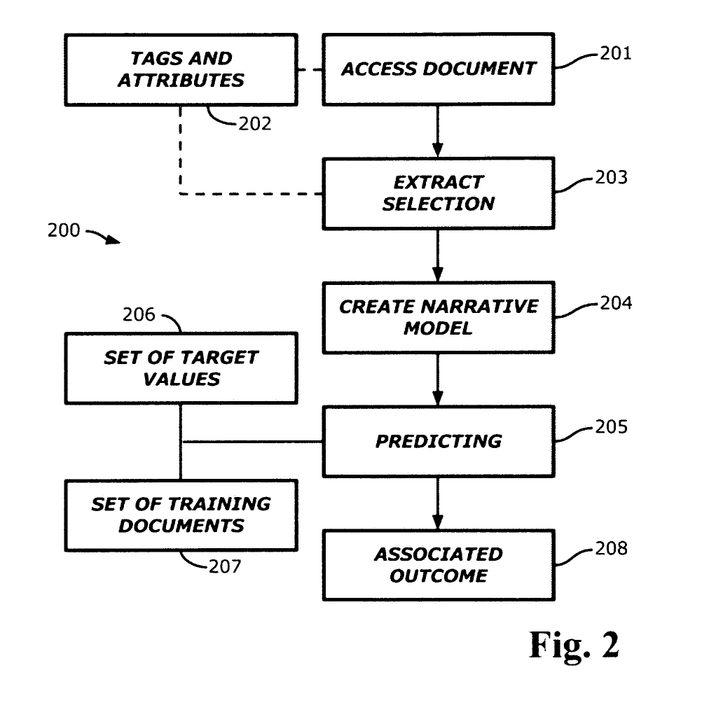

The flow diagram of the analysis method 200 to be used by the system 100 is shown in FIG. 2. The accessed document 201 can be considered the input to the method, such as can be sent via a client computer 112. The accessed document 201 can be given with associated tags and attributes 202 that can be used in extracting a selection 203 of the text from the accessed document typically using natural language processing, based on a specific set of attributes or tags. The attributes 202 can alternatively or additionally be obtained automatically from the inherent properties of the accessed document 201, such as the page number, section numbering, section ordering, or any document-type specific intrinsic or specified criteria. Similarly the tags 202 can alternatively or additionally be obtained automatically from the inherent content of the accessed document 201, such as the frequent headings, significant topics identified by algorithms, or any document-type specific topic extraction method for instance using latent models based on the words in the documents. This makes the tags and attributes 202 as an optional input into the method 200 as they can be automatically generated if they are not supplied or in addition to the supplied tags and attributes 202. The extracted selections 203 from the accessed document 201 are then stored into elements retaining its sequential ordering based on the document's temporal succession or according to a specific set of attributes, such as the page number, section numbering, section ordering or any other sequentially ordering characteristic. The elements now store the text of each selection and the indexing of the elements is set based on the derived ordering.

A narrative model is created 204 by deriving the semantics of the elements from the extracted selection 203 based on their indexing. The semantics of the elements can be derived using statistical methods based on the textual content of the elements including one or a combination of sentiment analysis, semantic analysis, latent class analysis, support vector machines, semantic orientation—pointwise mutual information, and any document-type specific analysis. Sentiment analysis has various embodiments possible but generally aims to determine the intended attitude of a the text of the element or subunits of the element with respect to some topic or the overall contextual polarity. The extraction of selected portions of documents 203 varies depending on the nature of the documents but typically consists of either a preset criteria for separation of the documents or can be set per instance. In the film related embodiment, each element of the film script document would be a scene. For TV series, an element could also be generalized to an episode with subelements defined as the scenes within the episode. The selection step also consists of the separation of every word in the separated elements of the document. While the extraction 203 of the accessed document 201 into elements and the derived semantics of each element may be full of valuable data, the narrative model 204 brings forth another unique level of insight into the accessed document 201 by giving a further breakdown of the evolution of the semantics over the lifespan of the accessed document 201 based on the derived indexing. An embodiment of the narrative model may record the semantic data into system 100 as a contingency matrix or as set of semantic descriptor vectors derived from the contingency matrix and related document descriptors. Wherein the semantic descriptors may involve topic vectors for individual elements, sentiment analysis descriptors and similar descriptors derived from automatic text analysis.

One of the goals of the disclosed invention is to create a mapping of the accessed document to an associated target value outcome 208. The predicting 205 is done by finding a mapping between a set of training documents 207 and their associated set of target values 206 and applying this mapping to the accessed document. In one embodiment, fitting a prediction can be done using various machine learning techniques that create a mapping between features extracted from the set of training documents 207 and target values 206 and using this mapping for predicting an outcome for a new input, in our case parameters of the narrative model created from the accessed document. It is evident therefore that fitting is done between narrative model parameters of the set of training documents 207 and the target values 208 using same narrative model method as applied to the accessed document. In some embodiments, only partial parameters of the narrative model may be used for fitting and predicting, such as was done in the case of extracting a selection 203 of the accessed document.

The flow diagram 300 outlines additional details that may be used in the transition of the narrative model 204 into an input for the prediction 205 of the associated outcome 208 as is shown in 312, for the elements 301 derived from accessed document 201 or from the training documents 207. In one of the simpler embodiments, a way to account for changes in semantics of a sequence of document elements 301 is to create a matrix of word counts that appear in every element. To construct such a matrix, a set of all words that appear across all elements is created. Using a count of word frequencies per each element establishes a contingency table or cross-tabulation matrix 302 where each row is a particular element and each column is a word frequency. However, rather than only using the word frequency, it may aid in the system's accuracy to express each element by the proportion of the word usage across elements. This is implementable by dividing each row by its sum to get a normalized matrix 303. In another embodiment of the process, the contingency table 302 is normalized by the row or column masses, where “mass” refers to the sum of the row or column contributions, respectively. In another embodiment, the differences between the different elements can be examined by analyzing the matrix of deviations from an average element. In such embodiment, a matrix is created from an exterior vector product of the row and column masses and is subtracted from the contingency matrix, and the rows and columns of the resulting matrix are normalized by multiplying the matrix from left and right by a square root of row and column masses, respectively. The column weights reflect how important a feature is for discriminating between elements.

One of the difficulties in detecting similarities between documents using the contingency table approach is that different words with similar meanings are counted separately. In such case using frequencies of occurrence of words might not sufficiently reveal similarities between elements that express similar ideas or topics but use different words to describe it. In another embodiment, distributed word representation 307 is used to compute similarity across words by weighting positively words that have related meaning even when the specific word does not appear in a specific element. A cosine-distance or some other similarity measure between words is used to modify the count of word appearances by adding to each word the relative frequency of other words weighted by their similarity to that word. This may be done by considering the totality of words that are common to the set of documents in a predefined corpus 306. In the film embodiment such a corpus may be the set of all words in a movie script or multiple related scripts, related by topic, genre, community 311 or any other attribute. Modifying the word frequency data can effectively eliminate problems of sparsity and biases that rare words can cause in later stages after 303.

One aspect of the proposed system relates to a combination of semantic lexicons 308 in the process of contingency matrix transformation 303 by using distributed representations 307 in order to be able to capture the semantics of the elements that goes beyond the frequency data of single words. To model complex texts such as acts of storytelling depicted in a film script or other narrative based text documents with a computing machine, it is desirable to have a method that is able to capture related meanings of words across multiple elements, which is important for capturing and modeling changes in semantics of the set of elements throughout their sequencing. In one possible embodiment, the contingency matrix is transformed by a domain specific lexicon 308 that weights each word according to a distributed word representation 307. Representation of words as a distributed vector of features is important to capture related meanings, where words with related meanings have similar features. This distributed word representation can be considered as a more general approach to questions of synonyms and antonyms that are commonly addressed using a thesaurus. In many cases, words have similar or different meanings according on the context or domain where the words are used. In such cases, it is desirable to have a method that can capture semantic similarity between words that are specific to the domain in question. In such an embodiment, the distributed representation of words is derived from two-layer neural net or other feature learning methods that processes text. Its input is a text corpus 306 and its output is a set of feature vectors for words in that corpus that is constructed specifically for the domain in question and is included in the invention as one of the elements of representing domain specific knowledge (306, 307, 308) as part of the narrative modeling process (301, 302, 303, 304, 305, 310). The community selection process 311 can interact with the descriptors of the document 309 to select specific lexicon 308 and weight the prediction of the associated outcome 312.

In order to capture the semantics of the elements, the contingency matrix or a transformed contingency matrix may need to be further processed by one of a variety of topic or latent analysis methods. In one embodiment of the proposed system, the transformed and normalized contingency matrix X 303 is processed by dimensionality reduction method 304 for deriving a lower-rank approximation by using the k largest singular values from a singular value decomposition (SVD) of the matrix X=UDV^{T} where U and V are orthogonal matrices and D is a diagonal matrix containing the singular values in question. Using this decomposition allows one to find the best k rank approximation for X. In such embodiment, a mass can be assigned to each row and weight to each column in 304. The mass of each row reflects how important that element is to the entire document or the proportion of a particular row in the sample. In a film embodiment, this could be the importance of a scene to the movie plot as a whole. Finally, the row and thusly its corresponding element can be represented by a factor score, in essence the projections of the observations onto the singular vectors. The singular vectors can be considered as latent semantic vectors found in the document and each element becomes a point in the latent space spanned by these semantic vectors. The end result can be stored as a new matrix, where each element is now a vector of factor scores that is in essence a semantic descriptor for that element. The variance of values for a single dimension (column) of this matrix is equal to the eigenvalue of the dimension. Thus, by selecting few dimensions of the vector with highest singular values results in an optimal lower rank representation of the element in terms of its partial factor scores that accounts for the most variance in the document. Accordingly, it is possible to embed the document, and thus represent its elements, in a lower rank semantic space with a notion of distance in that space capturing aspects of semantic difference or semantic change between the elements themselves.

In another possible embodiment, lower-rank representation 304 can be derived using factor analysis or one of a variety of latent modeling methods, such as Latent Semantic Indexing (LSI), Latent Dirichlet Allocation (LDA) and more. Beyond such specific methods, a person skilled in the art may find use of a number of general statistical methods for finding latent vectors to represent document topics that can be applied to both probabilistic and distributed word representations of contingency matrix. It is further possible to extract document descriptors 309 by using such methods on a corpus of documents. In such cases, the latent representations capture overall semantic description of a corpus rather than a semantic description specific to a set of elements in a document. Thus it is important to distinguish between two types of use of the method in 304, one that applies to fine grained semantics derived from a sequence of elements in a document and thus capturing semantics specific to that document, and the other capturing overall semantics of a corpus. It is possible to use a combination of both methods so that the fine grained analysis of elements is done using a contingency matrix created from word counts for each element, and another analysis can be performed on contingency matrix created from word counts of multiple documents in a corpus. In the case of capturing overall semantics of a corpus, the latent topics derived from the corpus are used to represent semantics of the document in relation to the semantic representation common to the corpus. In one possible embodiment, using the top words in the top topics found in the corpus can be used as descriptors 309 in representing the document in relation to corpus 306 or any other commonly agreed corpus relevant to the task.

The time modeling method 305 takes as input a sequence of semantic descriptors derived by a low-rank representation 304. This sequence of vectors or multidimensional points in semantic space can be viewed as a function of time or as a function of some index or attribute that describes the ordering of the elements, or as a branching structure having several narrative paths. Branching narratives may occur in interactive stories or computer game scenarios, where multiple path possibilities are possible. Path possibilities may be embodied through providing multiple alternative sequences of elements that branch out and/or return to common elements, with some conditions as to what possible next element in a sequence of elements depending on some input data.

Different documents or different paths in a branching document can have a different number of elements from start to finish, which results in a different number of semantic descriptors, number of points in semantic space, or equivalently different number of features, describing that document. Returning to the film embodiment, this can be understood as different movies typically varying in length and having a different numbers of scenes. Since one of the purposes of the disclosed invention is predicting an outcome for a document using mapping from features to target values learned from other documents, it is desirable therefore to have different films represented by the same number of features 310 so that it can be possible to input the time-based features from element sequences of different length using an alignment transformation into a prediction 312 that maps the document to a target value. In one possible embodiment, B-spline interpolation, which “localizes” the activity in a time series by summarizing it over multiple points, can be used as an alignment transformation in 310 to represent a sequences of points of variable length in terms of a fixed number of coefficients. Of course, the same logic and procedure can be extended to other embodiments, using time based models to represent sequential data of different length by fixed number of parameters or coefficients.

A polynomial basis function can then be assigned in 310 to represent the values over a time interval. The resulting piecewise polynomial can be made smooth by constraining two adjoining intervals to be equal, as well as their first and second derivatives. In another embodiment, regression functions using Fourier basis or other basis functions can be used in 310 to derive a representation of variable sequences of vectors in terms of a fixed number of coefficients. In another embodiment, time warping methods could be used as an alignment transformation to compare sequences of semantic descriptors of different length that are derived from sequences having different number of elements, in order to derive a similarity between two different documents having different numbers of elements.

In the film related embodiment, the system uses these time modeling coefficients to represent films of various durations and film scripts of different lengths and different numbers of scenes using alignment transformation in such a way that their narrative model parameters are comparable. The number of coefficients is determined automatically based on the best prediction or minimal error of associated value as determined by the predictor on a test data set. Alternatively, the number of coefficients can be manually set by the user, or a combined method may be used to set that number.

After a set of narrative model parameters has been established on multiple documents, the system uses a prediction method 312 to map the relations between features derived from the narrative model and a target value or range of possible target values associated with these documents. The prediction method 312 can include classifiers and/or regression models or an ensemble model combining both. In one embodiment, a Classification And Regression Tree (CART) method can be used for creating the target prediction, where the target can be some success indicator or for the film embodiment it can be the ROI of a film. In another embodiment, a bagging procedure first creates bootstrapped data sets by repeatedly sampling the data with replacement. Each tree is trained on one of the bootstrapped data sets, and the final prediction for a single data point is made by taking the average over the prediction from each regression tree. For an unstable model such as CART which tends to overfit on the specific training set provided, this method of bagging allows us to “smooth” over the predicted values by taking the average of the ensemble's predictions. It has been shown that bagging will usually improve the estimate for highly variable predictors, which may be useful since CART is a highly variable model. In another embodiment, a further sampling of features can be used as part of the bootstrapping procedure. This method, known as Random Forest, may improve the performance if the features are correlated and the prediction is dominated by few features that create very similar trees at the first decision points. In another embodiment, the tree construction can be improved using gradient boosting methods that gradually add classifiers that optimally improve the prediction results for some loss function.

In order to make an accurate as possible prediction from a training set, a set of related documents can be determined by community selection process 311. Such selection is established by finding a set of documents sharing many descriptors or tags with the current document 309 through a community selection process 311. In a possible film related embodiment, one example of such tag sets is publicly available tag-genome data from grouplens.org, but not limited to this data set or any other tagging scheme computed using text analysis method described here. Since some of the tags might be related to description of the film that is not related to the script of the storyline itself, such as “all-star cast”, “award winner”, or other production and post-production information, only a portion of the features from the historical data may be selected in order to be used for prediction of a target values for a new film. In another embodiment, a subset of tags can be selected by first associating the film with a subset of related films, as explained next. The community selected in 311 can be used to select the lexicon 308 or in the calculation of the predictor outcome 312.

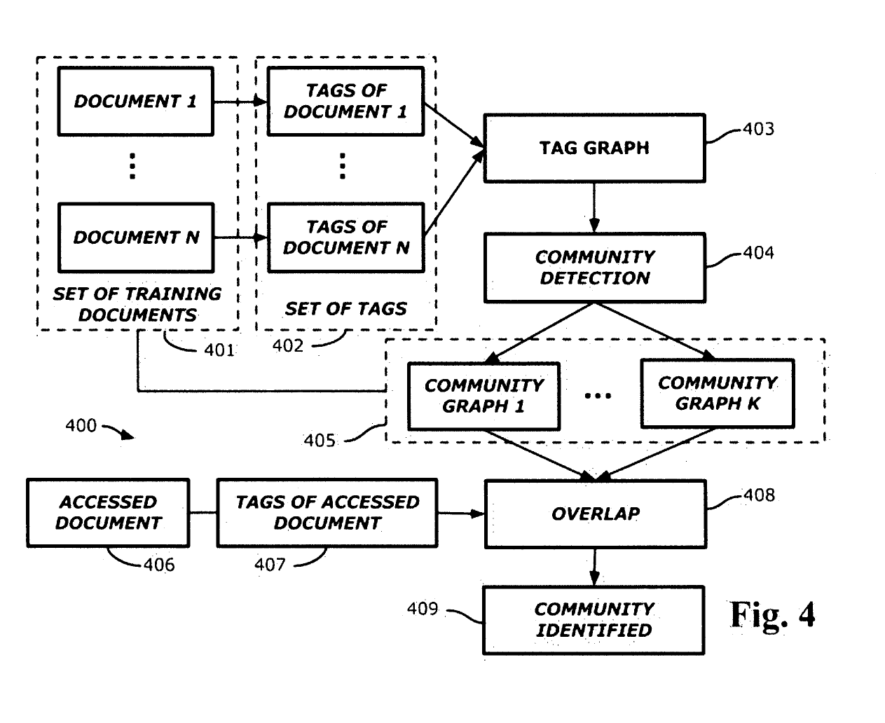

The flow diagram of the community analysis method 400 to be used by the system 300 in the community selection process 311 is shown in FIG. 4. Given a set of N documents 401 with a set of N tags 402, where N represents the number of documents and associated tags in the training set. The arbitrary collection of all tags can be represented in terms of a graph 403, where common tags that appear in different documents are linked by an edge. The graph of document tags 403 is created by collecting and linking tags that are related to each document, with the weight of the node being proportional to the number of appearances of the tag in the set of documents being used for training. The higher the number of documents that have the same pair of tags in common, the higher the weight of the link between the tags in the resulting graph representation. Once a tag graph is constructed using the set of documents and tags, graph community detection 404 can be used to partition the tag graph into subsets of related documents 405. In one possible embodiment, Louvain method of community detection is applied to the graph of document tags collected from the set of training documents and tags. The Louvain method is a greedy optimization method that attempts to optimize the “modularity” of a partition of the network. The optimization is performed in two steps. First, the method looks for “small” communities by optimizing modularity locally. Second, it aggregates nodes belonging to the same community and builds a new network whose nodes are the communities. These steps are repeated iteratively until a maximum of modularity is attained, and a hierarchy of communities is produced.

Given documents for analysis 406, such as a film script, the first step is to identify the closest community in the set of training documents to the accessed document. This can be done by finding the overlap 408 between the tags that describe the accessed document 407 and the tags that characterize communities 405 derived from the training set 401. It is important to realize that the partitioning method of the tag graph into community results in non-overlapping sets of tags. The tags of the accessed document 407 might overlap with more than a single community, and the amount of overlap 408 can be recorded in the output of the identified community 409 for later weighting of the prediction results 312. In the case of film script embodiment, this equates to running community detection 404 on a set of previously released film scripts in which there is partial overlap with the communities identified 409 for the accessed document, where the amount of overlap may be weighted by parameters such as centrality of the node representing a tag in the tag graph and identified by graph theoretic algorithms. The amount of overlap can be further used to weigh differently the predicting of target value by weighing the mapping derived from documents with different amount of overlap to each community.

In order to improve the performance of the prediction, one possible embodiment performs training 313 and prediction 312 of the target value for each community. Limiting the prediction according to a subset of related documents from the set of training document may be important in order to provide the best prediction for the accessed document. The final result may be the prediction using the closest community or a weighted combination of predictions from more than one community, weighted by the community proximity or similarity to the accessed document. In an example embodiment, it is possible to normalize the cosine distance between the accessed document vector descriptors and the community vector descriptors to obtain the relative weighting for the combined value of the final prediction.

The system is not limited to only automatically extracted descriptors from documents but can intake a range of metadata and factors supplied by the author of the accessed document or a user involved in the accessed document. The metadata and factors can be inputted via a questionnaire for example. The questionnaire can be used to tag elements of the document or generate overall document descriptors. In a potential film embodiment, such a questionnaire could include but is not limited to surveys about story qualities, narrative events, audience impression, audience emotional response, product and branding response, or demographic specific questions. This questionnaire can use the entire document, related document or some representation of the document. Additionally or alternatively this questionnaire would focus on descriptors of the document or the elements rather than direct consumer survey regarding the associated outcome. This big data like information can be generated from crowdsourcing services, such as Mechanical Turk, to factor in human-generated responses or other human-provided data in response to elements of the accessed document or some representation of the document. The additional metadata and factors may be used by the prediction.

In another film related embodiment, the additional metadata and factors, having predictive value with respect to the outcome associated with the accessed document, may include but are not limited to data about talent characteristics and their performances in different territories wherein the associated outcome may include predicting casting success or choices. In another embodiment, metadata and factors can link other information to aspects of the document that are not fully specified in the document or elements, such as names of actors linked to names of characters within the script, names of specific locations linked to locations within the script and so on. It is important to realize that a multitude of outcome predictions can be produced by the system and output to the user in form of a list, table or graph, or any other electronic or mathematical representation of the relations between alternatives of linked metadata and factors to the document and representing as outcome a multitude of alternatives. As one possible embodiment the associated outcome can represent a table or graph relating the costs of talent according to casting alternative and the ROI of the film, including a range of variation or some figure of risk and uncertainty around every possible alternative.

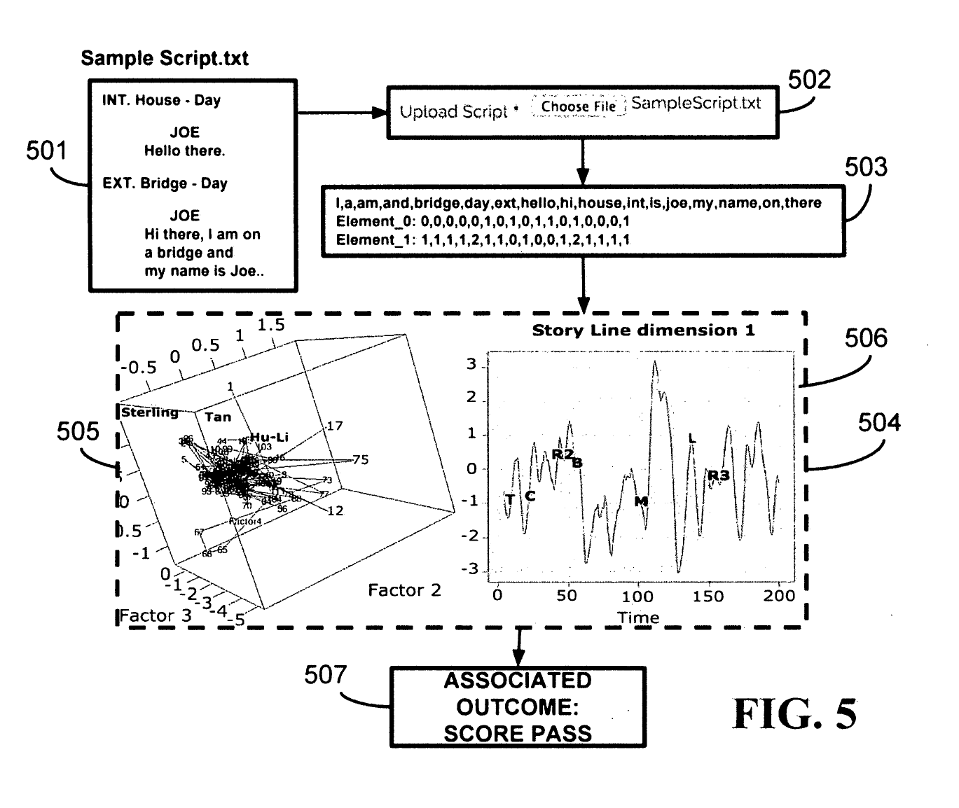

FIG. 5 shows a film related example embodiment for a possible use of the system. Accessed document 501 is uploaded by the user 502 and subject to narrative modeling. The accessed document 501 is a simplistic example of a film script titled SampleScript.txt. Only the step of the narrative modeling that creates a contingency matrix is shown in 503 wherein it is clearly seen that SampleScript.txt is split into elements by scene and an example contingency matrix shows the word count frequency break down of the elements. An example output of narrative modeling 503 is a set of parameters describing document semantics and their time evolution 504. The totality of parameters in the narrative model and operations on these parameters allow deriving various conclusions regarding the contents of the document. In one embodiment, the outcome of the analysis is associating an outcome 507 demonstrated as a success target score “Pass”. This is taken from the movie industry standard of scoring scripts as “Pass”, “Consider” and “Recommend” categories. Other operations on the narrative model comprise of selections of attributes and dimensions according to which input parameters to the outcome association function are supplied. In another embodiment the narrative model is used for visualization of the evolution of document semantics 505 along several factor scores that is in essence a sequential trajectory of semantic descriptors of the elements represented in terms of their coordinates in a semantic space according to selected dimensions. It should be noted that visualizations 505 and 506 are of a different set of elements than those from SampleScript.txt 501 in order to show more realistic visualizations of documents of a more typical number of elements than the two in elements in 503. The cube visualization 505 represents a three dimensional semantic space mapping of the elements numbered and linked in their indexed order as can be seen as number with additionally character's names displayed to show their location in the semantic space to give reference points when viewing the visualization. Furthermore, visualization such as 505 can be specified to dialog occurrences, evolution in sentiment of a particular character in a film, and so on. Changes in semantics of the scenes over time can be limited along one of the semantic dimensions 506. In 506 the graph shows a projection of the elements in semantic space onto one dimensions in which the horizontal axis represents the element index number or sequential ordering, or equivalently in the film embodiment it would be the element's scene number, and the vertical axis shows the coordinate of each element along one of the dimensions, smoothed to values between the elements to create a continuous graph. In another embodiment, the narrative model is used for computation of distances between scenes, applying operations such as detecting points in 506 where big changes in document contents occur, analyzing the rate of change of these contents, such as rhythm or tempo of beat occurrences in a film, and so on. In another embodiment, specific scenes or points in time having particular semantic attributes over the duration of the movie can be extracted. Such selections can be done according to screenwriting theories that specify particular significant points in time along the movie duration, known as beat sheets or story events, and using those points as features for prediction. In 506 further markers were placed along the visualization to represent beat sheets of story events along the narrative such as the location of the theme stated (T), catalyst (C), break into two (R2), B story (B), midpoint (M), all is lost (L) and break into three (R3) points within the story relating to a script considering the film related embodiment.

In typical content discovery application a system will find and report documents to a user based on attributes that are shared across users, such as similar tastes, content preferences or sharing some other user defined or objective characteristic. In order to make a discovery for one user the system has to find another user who has already discovered a relevant document, which is manifested by the document being present in a list of documents describing the preference or some other usage pattern of these documents by these other users. Such systems can not operate on new documents that have not yet been discovered by the other users. It is thus desirable to be able to enter into the system new documents by predicting a new target value for the new document by matching the document properties of the accessed document to other existing documents. In one embodiment of the system, the associated outcome can be a collection of user preferences for documents. In another embodiment, the associated outcome can be taste, contextual preference, relevance or any other indicator that maps documents to a target value or class. When a new document is entered into the system, the system uses its prediction capabilities for predicting the target value of the new document. Moreover, the nearest documents that were found by the system for the purpose of making the prediction can be reported as content discovery output. In the case where multiple predictors are used to provide the results, the recommended content output can be weighted or ranked according to similarity between the target values of the user and other users on a shared set of documents. In another embodiment, the system can predict a potential rating or preference of an active user towards a desired document based on the user's rating of other documents or data, or ratings of other users that exhibit similar associated outcomes on other related documents. Finally, after making potential ratings the proposed system will recommend some items that the user is most likely to enjoy or find relevant for the specific content discovery task.

What is claimed is:

1. A method comprising:
accessing a document with attributes and tags that sequentially order elements of the document;
extracting a selection of document text belonging to a specific set of attributes;
creating a narrative model that represents evolution of semantics with respect to the sequentially ordered elements;
accessing a set of target values and training documents, wherein the target value quantifies an outcome associated with one or more of the training documents in the set; and
predicting an outcome associated with the accessed document.

2. The method of claim 1, wherein the semantics includes:
statistical methods including one or a combination of sentiment analysis, semantic analysis, pragmatics analysis, latent class analysis, support vector machines, semantic orientation, pointwise mutual information and any document-type specific analysis.

3. The method of claim 1, further comprising:
associating the training documents with communities;
training a classifier between the communities and the target values;
detecting relationships between the elements of the accessed document and the communities;
calculating weighting based on the detected relationships,
and wherein predicting the outcome is based on the classifiers and the calculated weightings.

4. The method of claim 3, wherein:
obtaining a collection of topics over a corpus of documents using latent models based on the words in those documents,
and using significant words in the significant topics representing a document as tags in associating documents with communities.

5. The method of claim 3, further comprising:
training multiple predictors between the communities and the target values, and
wherein predicting the outcome is further based on these predictors.

6. The method recited in claim 1, wherein the accessed document includes:
a collection of elements arranged in its temporal succession in which elements of the documents can be accessed according to a specific set of attributes.

7. The method recited in claim 1, wherein creating the narrative model includes:
creating a branching narrative that represents multiple path possibilities when applicable to the document.

8. The method of claim 1, wherein generating a prediction includes:
creating narrative models for the training documents, wherein generating the prediction is further based on the narrative models for the training documents.

9. The method recited in claim 1, wherein creating the narrative model includes:
generating a sequence of semantics descriptor vectors that are indexed to the sequentially ordered elements;
analysing the change and association of semantics from element to element within documents with one or more additional features, tags, attributes; and
representing as a collection of vectors.

10. The method recited in claim 1, wherein creating the narrative model includes:
generating a contingency matrix; and
using the contingency matrix in semantically analyzing the document, wherein semantically analyzing the document yields data that is inputted to the narrative model.

11. The method recited in claim 10 further comprising:
training a lexicon of distributed word vectors on individual words with generative models that represent topics as frequencies of words and tracing rates of word usage with respect to the elements in the document, and wherein:
generating the contingency matrix includes modifying word frequency data using the lexicon.

12. The method of claim 1, wherein predicting the outcome includes:
transforming the narrative model through alignment transformation to match the number of coefficients between models with different numbers of elements.

13. The method of claim 1, wherein predicting the outcome further includes:
training a classifier using the set of target values and training documents; and
inputting the narrative model into the classifier wherein the classifier is used to generate the prediction.

14. The method of claim 1, wherein predicting the outcome includes:
training an ensemble model that includes classifiers and/or regression models using the set of target values and training documents; and
using the narrative model from the accessed document with the ensemble model to predict the associated outcome.

15. A system comprising a processor having instructions operable to cause the processor to:
access a document with attributes and tags that sequentially order elements of the document;
extract a selection of document text belonging to a specific set of attributes;
create a narrative model that represents evolution of semantics with respect to the sequentially ordered elements;
access a set of target values and training documents, wherein the target value quantifies an outcome associated with one or more of the training documents in the set; and
generate a prediction of an outcome associated with the accessed document.

16. The system of claim 15, wherein the semantics includes:
applying statistical methods including one or a combination of sentiment analysis, semantic analysis, pragmatics analysis, latent class analysis, support vector machines, semantic orientation, pointwise mutual information and any document-type specific analysis.

17. The system of claim 15, further comprises:
associate the training documents with communities;
train a classifier between the communities and the target values;
detect relationships between the elements of the accessed document and the communities;
calculate weighting based on the detected relationships,
and wherein the prediction of the outcome is based on the classifiers and the calculated weightings.

18. The system of claim 15 being embedded in a word processing system.

19. The system of claim 15, wherein the prediction includes:
metadata and factors having predictive value with respect to the outcome associated with the accessed document.

20. The system of claim 15, wherein the prediction:
finds documents in a database that are closest in terms of outcome associated with the accessed document as found by the prediction method, and
reports these documents as a content discovery output.
